(19) United States
(12) Patent Application Publication
(10) Pub. No.: US 2013/0288039 A1
(43) Pub. Date: Oct. 31, 2013

(54) Transparent Conductive Laminate

(71) Applicants: Chien-Cheng Chang, Zhongli City (TW); Yu-Chun Chien, Zhongli City (TW); Da-Shan Lin, Zhongli City (TW); Han-Hsiang Lin, Zhongli City (TW)

(72) Inventors: Chien-Cheng Chang, Zhongli City (TW); Yu-Chun Chien, Zhongli City (TW); Da-Shan Lin, Zhongli City (TW); Han-Hsiang Lin, Zhongli City (TW)

(73) Assignee: FAR EASTERN NEW CENTURY CORPORATION, Taipei (TW)

(21) Appl. No.: 13/609,742

(22) Filed: Sep. 11, 2012

(30) Foreign Application Priority Data
Apr. 25, 2012 (TW) 101114718

(51) Int. Cl. B32B 15/082; B32B 5/16; B32B 15/095; B32B 15/088; B05D 5/12; B32B 27/06; B32B 15/09; B82Y 30/00

(52) U.S. Cl. 428/323; 428/336; 427/122; 977/742; 977/750; 977/752

(57) ABSTRACT

A transparent conductive laminate includes a conductive multilayer and a corrosion-resistant film. The corrosion-resistant film is essentially consisting of waterborne polyurethane and a plurality of carbon nanotubes dispersed therein, free of corrosion inhibitor. The corrosion-resistant film not only can protect the conductive multilayer, but also keep the surface resistance of the transparent conductive laminate. Further, the chromatism of the conductive multilayer is improved accordingly.

### RELATED APPLICATIONS

This application claims priority to Taiwan Application Serial Number 101114718, filed Apr. 25, 2012, which is herein incorporated by reference.

### BACKGROUND

1. Technical Field

The present disclosure relates to a transparent conductive laminate, and more particularly, to a transparent conductive laminate including a corrosion-resistant film.

2. Description of Related Art

A transparent conductive laminate has been applied in various electronic devices, such as a liquid crystal display device, a touch panel and a solar cell. To exhibit good conductivity, the transparent conductive laminate generally applies silver as a main material so as to form a silver conductive layer. The silver conductive layer may form a laminated structure with an indium tin oxide (ITO) layer as required. For instance, two of the ITO layers can be individually disposed on both sides of one silver conductive layer to form a conductive multilayer (ITO/silver/ITO).

Under ambient conditions, oxygen and moisture in air may penetrate the indium tin oxide layer with less dense structure and oxidize the silver layer to corrosively form white spots. Due the insulative nature of the white spots, many densely formed white spots would increase the electric resistance of the conductive multilayer and even break the circuitry in the electronic devices.

Therefore, it was suggested in the art that the formation of the white spots might be inhibited by the process of sputtering gold, adding a barrier layer or adding corrosion inhibitor. Those processes may more or less reduce the formation of the white spots; however, all the processes, other than sputtering gold which is rather expensive, normally result in the increase of the surface resistance of the conductive multilayer. Further, it is known in the art that the conductive multilayer including the ITO layer would introduce the chromatism in yellow. However, none of the aforementioned processes can improve the problem of chromatism simultaneously.

For example, an electromagnetic shielding coating material composed of dual-component polyurethane resin, metal conductive material (copper powder) and an azole-based organic corrosion inhibitor is disclosed in the U.S. Pat. No. 5,061,566 (1991). However, the corrosion inhibitor of the coating material not only causes environmental pollution, but also affects the transmittance of the coating material while adding excessive metal conductive material.

In addition, a coating solution exhibiting conductive property and anti-corrosion and including various conductive materials, a corrosion inhibitor and adhesive is disclosed in the United States Patent Application No. 2011/0236710 (2011). The coating solution is claimed having the conductive and anti-corrosion properties, but its preparation is quite complicated and requires a great number of materials. Further, clay, which reduces the transparency of the coating layer, should be added to achieve the effect of anti-corrosion.

Given the above, there is still a need for a technical solution to effectively solve those problems in the art.

### SUMMARY

The inventors provide a transparent conductive laminate to effectively solve the problems mentioned in the prior art.

According to one embodiment of the present disclosure, the transparent conductive laminate includes a conductive multilayer and a corrosion-resistant film. The conductive multilayer includes a substrate and a metal conductive layer. The corrosion-resistant film is essentially consisting of waterborne polyurethane (PU) and a plurality of carbon nanotubes dispersed therein, free of corrosion inhibitor. Further, a thickness (denoted as x nm) of the corrosion-resistant film and a content (denoted as y v/v %) of the carbon nanotubes have a relationship:

y=−2.9x+a (formula I),

in which y is in a range of 3 to 32, and a is in a range of 100 to 400.

Another purpose of the present disclosure is to provide a method for manufacturing the transparent conductive laminate described above. A conductive multilayer is provided. A corrosion-resistant solution including solvent, a plurality of carbon nanotubes and waterborne polyurethane is prepared. The corrosion-resistant solution is coated on the conductive multilayer. Subsequently, the corrosion-resistant solution is dried to form the corrosion-resistant film on the conductive multilayer.

A thickness (denoted by x nm) of the corrosion-resistant film and a content (denoted by y v/v %) of the carbon nanotubes have a relationship:

y=−2.9x+a (formula I),

in which y is in a range of 3 to 32, and a is in a range of 100 to 400.

The corrosion-resistant film of the present disclosure not only can protect the conductive multilayer, but also keep the surface resistance of the transparent conductive laminate. Further, the chromatism of the conductive multilayer is improved accordingly.

### BRIEF DESCRIPTION OF THE DRAWINGS

The disclosure may be more fully understood by reading the following detailed description of the embodiment, with reference made to the accompanying drawings as follows:

FIG. 1A is a schematic diagram of a transparent conductive laminate 100a according to one embodiment of the present disclosure;

FIG. 1B is a schematic diagram of a transparent conductive laminate 100b according to one embodiment of the present disclosure;

FIG. 1C is a schematic diagram of a transparent conductive laminate 100c according to one embodiment of the present disclosure; and

FIG. 2 is a relationship diagram between a thickness of a corrosion-resistant film and a content of carbon nanotubes therein according to one embodiment of the present disclosure, in which an enclosed area split by four straight lines is a usable range.

### DETAILED DESCRIPTION

The present disclosure is described by the following specific embodiments. Those with ordinary skill in the arts can readily understand the other advantages and functions of the present disclosure after reading the disclosure of this specification. The present disclosure can also be implemented with different embodiments. Various details described in this specification can be modified based on different viewpoints and applications without departing from the scope of the present disclosure.

As used herein, the singular forms “a,” “an” and “the” include plural referents unless the context clearly dictates otherwise. Therefore, reference to, for example, a data sequence includes aspects having two or more such sequences, unless the context clearly indicates otherwise.

Reference will now be made in detail to the embodiments of the present disclosure, examples of which are illustrated in the accompanying drawings. Wherever possible, the same reference numbers are used in the drawings and the description to refer to the same or like parts.

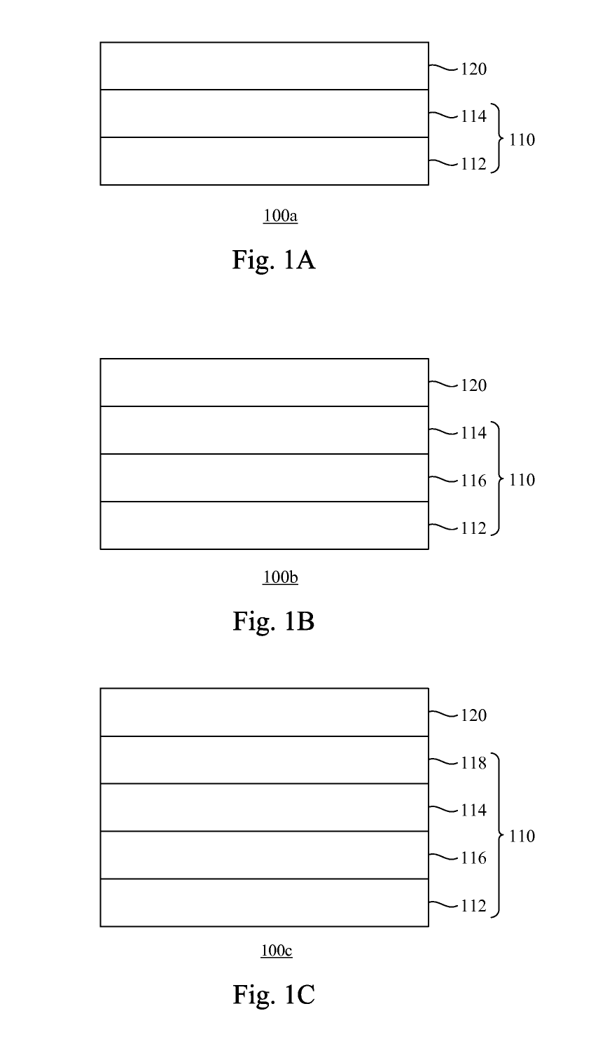

FIG. 1A is a cross-section view of a transparent conductive laminate 100a according to one embodiment of the present disclosure. The transparent conductive laminate 100a includes a conductive multilayer 110 and a corrosion-resistant film 120 disposed thereon.

According to one embodiment of the present disclosure, the conductive multilayer 110 includes at least one substrate 112 and a metal conductive layer 114. The corrosion-resistant film 120 is disposed on the metal conductive layer 114 and is consisting essentially of waterborne polyurethane and carbon nanotubes dispersed therein, free of corrosion inhibitor.

According to one embodiment of the present disclosure, the substrate 112 is a polymer selected from the group consisting of polyester-based resin, acetate-based resin, polyether-based resin, polycarbonate-based resin, polyamide-based resin, polyimide-based resin, polyolefin-based resin, acrylic resin, polyvinyl chloride-based resin, polystyrene-based resin, polyvinyl alcohol-based resin, polyarylate-based resin, polyphenylene sulfide-based resin, polyvinylidene chloride-based resin and a combination thereof.

According to one embodiment of the present disclosure, the metal conductive layer 114 is selected at least one from the group consisting of silver, aluminum, copper and a combination thereof. The metal conductive layer 114 has a thickness ranging from 3 nm to 15 nm, preferably from 5 nm to 10 nm. If the thickness of the metal conductive layer 144 is less than 3 nm, it may cause a circuit to break and exhibit poor conductivity. In contrast, if the thickness of the metal conductive layer 114 is larger than 15 nm, the light transmittance thereof may be poor.

According to another embodiment of the present disclosure, as shown in FIG. 1B, the metal conductive layer 114 is disposed between the substrate 112 and the corrosion-resistant film 120. Further, a first conductive layer 116 is disposed between the metal conductive layer 114 and the substrate 112, and a second conductive layer 118 is disposed between the metal conductive layer 114 and the corrosion-resistant film 120.

The first conductive layer 116 and the second conductive layer 118 respectively are metal or metal oxide. The metal is selected at least one from the group consisting of silver, aluminum, copper and a combination thereof. The metal oxide is selected at least one from the group consisting of indium oxide, tin oxide, zinc oxide, indium tin oxide, indium antimony oxide, zinc aluminum oxide, indium zinc oxide and a combination thereof. The thickness of either the first conductive layer 116 or the second conductive layer 118 may be selected in accordance with the required electrical conductivity and other properties, preferably from 3 nm to 100 nm, better still from 20 nm to 70 nm, best from 30 nm to 60 nm.

According to another embodiment of the present disclosure, as depicted in FIG. 1C, the transparent conductive layer 110 only includes a first conductive layer 116. The skilled in the art after reading the description of the present disclosure can realize that the transparent conductive layer 110 may only includes a second conductive layer 118 as a variation of the embodiment (not shown) mentioned above.

According to one embodiment of the present disclosure, the corrosion-resistant film 120 is consisting essentially of waterborne polyurethane with hydrophilic groups and carbon nanotubes dispersed therein.

Water is acted as a solvent to the waterborne polyurethane with the hydrophilic groups to prepare aqueous solution. The waterborne polyurethane has superiority in operating or protecting environment compared to general polyurethane, which can only dissolve in organic solvent. According to one embodiment of the present disclosure, the hydrophilic groups of the waterborne polyurethane are selected from the group consisting of carboxylic acid group, sulfonic acid group, ammonium group, ethylene oxide group and a combination thereof.

According to one embodiment of the present disclosure, the carbon nanotubes are single-walled, double-walled or multi-walled. The carbon nanotubes have a length ranging from 1 μm to 20 μm, preferably from 5 μm to 20 μm, and better still from 10 μm to 20 μm. The carbon nanotubes have a diameter ranging from 1 nm to 50 nm, preferably from 1 nm to 30 nm, and better still from 3 nm to 25 nm. The dried corrosion-resistant film contains the carbon nanotubes in a range of 3 v/v % to 32 v/v % after drying. If the content of the carbon nanotubes is low, it may cause low probability of contacting each other and thus decreases electrical conductivity. If the content of the carbon nanotubes is high, it is not easy to prepare well-dispersed corrosion-resistant solution. The carbon nanotubes of the present disclosure are composed of double-walled and multi-walled carbon nanotubes.

A thickness of the corrosion-resistant film 120 (denoted by x nm) is preferably in a range of 23 nm to 137 nm. A content of the carbon nanotubes of the corrosion-resistant film 120 (denoted by y v/v %) is preferably in a range of 3 v/v % to 32 v/v %. There exists a mathematical relationship y=−2.9x+a (formula I), in which a is in a range of 100 to 400.

According to one embodiment of the present disclosure, a method for manufacturing the transparent conductive laminate includes forming the conductive multilayer 110 and the corrosion-resistant film 120. The conductive multilayer 110 includes the substrate 112 and the metal conductive layer 114, and further includes a first conductive layer 116 and a second conductive layer 118. Thus, during forming the conductive multilayer 110, a physical vapor deposition method is employed to form the metal conductive layer 114, and a physical vapor deposition method is then employed to form the first conductive layer 116 and the second conductive layer 118.

For the formation of corrosion-resistant film 120, there is a need for preparing a corrosion-resistant solution to the use of follow-up processes. First, the carbon nanotubes and the waterborne polyurethane (carbon nanotubes (wt %): waterborne polyurethane (wt %) is in a range of 1:1 to 1:10) are added into isopropanol aqueous solution (water (wt %): isopropanol (wt %) is in a range of 1:0.6 to 1:1). The aqueous solution (water (wt %): ispropanol (wt %) is preferably in a range of 1:0.7. After uniformly mixing, the corrosion-resistant solution is formed. According to the content of the carbon nanotubes of the corrosion-resistant film, both the carbon nanotubes and the waterborne polyurethane in the corrosion-resistant solution has a content ranging from 0.1 wt % to 1.0 wt %, preferably of 0.2 wt %.

Sequentially, the corrosion-resistant solution mentioned above is coated on the conductive multilayer 110 by such as a wire-bar coating method. The corrosion-resistant solution coated on the conductive multilayer 110 is then dried to form the corrosion-resistant film 120.

### EXAMPLES

The following Examples are provided to illustrate certain aspects of the present disclosure and to aid those of skill in the art in practicing this disclosure. These Examples are in no way to be considered to limit the scope of the disclosure in any manner.

The types and the sources of the waterborne polyurethane of examples mentioned below are shown in Table 1.

TABLE 1
Composition of waterborne polyurethane

| No. | Type | Monomer of composition | Source vendor |
|---|---|---|---|
| WPU-1 | PC106K | Cycloaliphatics isocyanate + | OCEAN PLASTICS |
| | | Polycarbonate polyol | CO., LTD (Taiwan) |
| WPU-2 | DPU636 | Cycloaliphatics iso cyanate + | OCEAN PLASTICS |
| | | (Polycarbonate polyol/ | CO., LTD (Taiwan) |
| | | Polyether polyol) | |
| WPU-3 | DPU712 | Cycloaliphatics isocyanate + | OCEAN PLASTICS |
| | | Polyether polyol | CO., LTD (Taiwan) |
| WPU-4 | 986 | Aliphatics isocyanate + | EVERPURE CO., |
| | | Polycarbonate polyol | LTD (Taiwan) |

The tests for the transparent conductive laminates fabricated by the embodiments below are described hereinafter.

The test methods and evaluation criteria are illustrated below. The tests include haze, light transmittance, surface resistance, b* value and appearance.

The methods for testing haze and light transmittance are based on JIS K 7105 and use measuring instrument NDH-2000 (NIPPON DENSHOKU INDUSTRIES CO., LTD, NDK). The transparent conductive laminates of the present disclosure can be applied in the fields of display devices, E-papers, solar cells and lighting equipment. The common light transmittance should higher than 75% to maintain the efficiency of the final products. In the present disclosure, in addition to the content of the carbon nanotubes and the thickness of the corrosion-resistant film, the thickness of other layers also need to appropriately determine to exhibit good light transmittance.

The method for testing the surface resistance is based on JIS K 7194 and uses measuring instrument Lotest AMCP-T400 (MITSUBISHI PETROCHEMICALS CO., LTD) with 4-terminal method.

The method for testing the b* value is based on blue-yellow index b* of L*a*b* of JIS, and uses spectrophotometer U4100 (HITACHI CO., LTD) according to JIS Z 8722. In one embodiment, the first conductive layer and/or the second conductive layer are indium tin oxide. In that indium tin oxide has less light transmittance for shorter wavelength, b* value is higher than 2.0 (partial yellow). Therefore, the carbon nanotubes exhibiting blue gray color can be used to adjust the problem of the chromatism in yellow (due to indium tin oxide) by obtaining a b* value ranging from −2.0 to 2.0 (neutral color) in forming corrosion-resistant transparent conductive film.

The method for testing appearance is to dispose the transparent conductive laminate in an environment of high temperature and high humidity for a period. The white spots generated after the test is observed by naked eyes and then calculated to give an evaluation. In an area of 300 cm² of the transparent conductive laminate, white spots≦3 is denoted by ⊚; 3<white spots≦10 is denoted by Δ; white spots>10 is denoted by X.

### Preparation of Transparent Conductive Laminate with Different Volume Ratio of Conductive Material to Thin Film Layer

### Example 1

A method for manufacturing a transparent conductive laminate includes steps below:
(1) A first conductive layer is sputtered. A substrate is placed in a sputtering chamber, and indium tin oxide (Sn/(In+Sn)=10 wt %) is acted as a target. After vacuuming the chamber, working gas is flowed thereinto to sputter the first conductive layer at an ambient temperature. The first conductive layer has a thickness of 56 nm. The working gas is a mixture gas of argon and oxygen.
(2) A metal conductive layer is deposited. After step (1), oxygen is closed and argon is continuously flowed to deposit the metal conductive layer on the first conductive layer, which silver is used as a target. The metal conductive layer has a thickness of 7 nm.
(3) A second conductive layer is sputtered. After step (2), the second conductive layer is sputtered on the metal conductive layer by the method of step (1). The second conductive layer has a thickness of 56 nm.
   The intermediate product fabricated by step (1) to (3) is tested by the test method mentioned above. The light transmittance of the intermediate is 87.17%. The surface resistance is 15Ω/□. The b* value is 6.49.
(4) A corrosion-resistant solution is prepared. The carbon nanotubes and WPU-1 are added into isopropanol aqueous solution (water (wt %): ispropanol (wt %) is 1:0.7), and then uniformly dispersed to form the corrosion-resistant solution containing 0.2 wt % of both the carbon nanotubes and the waterborne polyurethane.
(5) A corrosion-resistant film is coated. After step (3), the corrosion-resistant solution prepared by step (4) is coated on the second conductive layer by a bar coating method. After drying, the content of the carbon nanotubes of the corrosion-resistant film is 4.06 v/v % calculated by the density of the carbon nanotubes (2.6 g/cm³) and the density of the waterborne polyurethane (1.1 g/cm³). The corrosion-resistant film has a thickness of 40 nm.
(6) The corrosion-resistant film is tested for corrosion-resistant test.

The transparent conductive laminate is placed in a specific environment (temperature: 60° C., humidity: 90%) for 240 hours. Sequentially, the film is tested for haze, light transmittance, surface resistance, b* value, and appearance by the test methods mentioned above.

### Examples 2 and 3

The steps for fabricating the transparent conductive laminates of examples 2 and 3 are the same as steps (1) to (3), (5) and (6) of example 1, and step (4) is changed to add the carbon nanotubes and WPU-2 into isopropanol aqueous solution (water (wt %): ispropanol (wt %) is 1:0.7), and then uniformly dispersed to form the corrosion-resistant solution containing 0.2 wt % of both the carbon nanotubes and the waterborne polyurethane. After drying, the content of the carbon nanotubes of the corrosion-resistant film is 29.73 v/v %. The corrosion-resistant film of example 2 has a thickness of 30 nm. The corrosion-resistant film of example 3 has a thickness of 40 nm.

### Comparison 1:

It is the intermediate element of example 1, free of corrosion-resistant film; that is to say, the intermediate element only includes the first conductive layer, the metal conductive layer and the second conductive layer. The steps for preparing the intermediate element of comparison 1 are the same as steps (1) to (3) and (6) of example 1, free of steps (4) and (5).

### Comparisons 2 to 4:

The steps for fabricating the transparent conductive laminates of comparisons 2 to 4 are the same as steps (1) to (6) of example 1. The corrosion-resistant film of comparison 2 has a thickness of 10 nm. The corrosion-resistant film of comparison 3 has a thickness of 20 nm. The corrosion-resistant film of comparison 4 has a thickness of 30 nm.

### Comparisons 5 and 6:

The steps for fabricating the transparent conductive laminates of comparisons 5 and 6 are the same as steps (1) to (3), (5) and (6) of example 1, and step (4) is changed to add the carbon nanotubes and WPU-3 into isopropanol aqueous solution (water (wt %): ispropanol (wt %) is 1:0.7), and then uniformly dispersed to form the corrosion-resistant solution containing 0.2 wt % of both the carbon nanotubes and the waterborne polyurethane. After drying, the content of the carbon nanotubes of the corrosion-resistant film is 29.73 v/v %. The corrosion-resistant film of comparison 5 has a thickness of 30 nm. The corrosion-resistant film of comparison 6 has a thickness of 40 nm.

### Comparison 7:

The steps for fabricating the transparent conductive laminate of comparison 7 are the same as steps (1), (2), (5) and (6) of example 1, free of steps (3) and (4). WPU-1 (free of carbon nanotubes) is coated on the metal conductive layer. The corrosion-resistant film of comparison 7 has a thickness of 120 nm.

### Comparison 8 to 11:

The steps for fabricating the transparent conductive laminates of comparisons 8 to 11 are the same as steps (1) to (3), (5) and (6) of example 1, free of step (4). A variety of WPUs (free of carbon nanotubes) are respectively coated on the second conductive layers. WPU-2 is used in Comparison 8. WPU-3 is used in Comparison 9. WPU-4 is used in Comparison 10. Epoxy acrylate is used in Comparison 11. The thickness of the corrosion-resistant films of Comparisons 8 to 11 is 120 nm.

### Comparison 12:

The steps for fabricating the transparent conductive laminate of comparisons 12 are the same as steps (1), (2), (5) and (6) of example 1, free of step (3). Step (4) is changed to add PEDOT: PPS and WPU-4 into isopropanol aqueous solution (water (wt %): ispropanol (wt %) is 1:0.7), and then uniformly dispersed to form the corrosion-resistant solution containing 0.2 wt % of both the PEDOT:PSS and the waterborne polyurethane. After drying, the content of the carbon nanotubes of the corrosion-resistant film is 29.73 v/v %. The corrosion-resistant film of comparison 12 has a thickness of 120 nm.

The compositions and the structures of examples 1 to 3 and comparisons 1 to 12 are illustrated in Table 2, and the test results are also summarized in Table 3.

TABLE 2

| | Corrosion-resistant film | | | | |
|---|---|---|---|---|---|
| | | | Content of | | |
| | | | carbon | | |
| | | | nanotubes | Thickness | |
| | Carbon | | of thin film^{c} | of thin film^{c} | Structure of |
| | nanotubes | WPU | (v/v %) | (nm) | transparent laminate^{d} |
| Example 1 | Yes | WPU-1 | 4.06 | 40 | . . . Ag/ITO/thin film^{c} |
| Example 2 | Yes | WPU-2 | 29.73 | 30 | . . . Ag/ITO/thin film^{c} |
| Example 3 | Yes | WPU-2 | 29.73 | 40 | . . . Ag/ITO/thin film^{c} |
| Comparison 1 | None | None | None | None | . . . Ag/ITO |
| Comparison 2 | Yes | WPU-1 | 4.06 | 10 | . . . Ag/ITO/thin film^{c} |
| Comparison 3 | Yes | WPU-1 | 4.06 | 20 | . . . Ag/ITO/thin film^{c} |
| Comparison 4 | Yes | WPU-1 | 4.06 | 30 | . . . Ag/ITO/thin film^{c} |
| Comparison 5 | Yes | WPU-3 | 29.73 | 10 | . . . Ag/ITO/thin film^{c} |
| Comparison 6 | Yes | WPU-3 | 29.73 | 20 | . . . Ag/ITO/thin film^{c} |
| Comparison 7 | None | WPU-1 | 0 | 120 | . . . Ag/thin film^{c} |
| Comparison 8 | None | WPU-2 | 0 | 120 | . . . Ag/ITO/thin film^{c} |
| Comparison 9 | None | WPU-3 | 0 | 120 | . . . Ag/ITO/thin film^{c} |
| Comparison 10 | None | WPU-4 | 0 | 120 | . . . Ag/ITO/thin film^{c} |
| Comparison 11 | None | Epoxy | 0 | 120 | . . . Ag/ITO/thin film^{c} |
| | | acrylate^{b} | | | |
| Comparison 12 | PEDOT: | WPU-4 | 29.73 | 120 | . . . Ag/ITO/thin film^{c} |
| | PSS^{a} | | | | |

^{a}in comparison 12, PEDOT:PSS is acted as the conductive material to substitute carbon nanotubes;
^{b}in comparison 11, epoxy acrylate is used to replace WPU;
^{c}the thin film is the corrosion-resistant film;
^{d}in the structure of the transparent conductive laminate, “. . .” is a abbreviation of “PET/ITO/”.

TABLE 3

| | | Light | | | |
|---|---|---|---|---|---|
| | | transmit- | | Surface | |
| | Haze | tance | b* | resistance | Appear- |
| | (%) | (%) | value^{a} | (Ω/□) | ance^{b} |
| Example 1 | 0.79 | 82.71 | 1.66 | 15 | ⊚ |
| Example 2 | 0.87 | 81.73 | 1.43 | 15 | ⊚ |
| Example 3 | 0.87 | 80.98 | 0.93 | 15 | ⊚ |
| Comparison 1 | 0.51 | 87.17 | 6.49 | 15 | X |
| Comparison 2 | 0.73 | 85.73 | 5.59 | 15 | X |
| Comparison 3 | 0.63 | 83.47 | 5.12 | 15 | ⊚ |
| Comparison 4 | 0.94 | 83.02 | 2.58 | 15 | ⊚ |
| Comparison 5 | 0.76 | 83.79 | 4.75 | 15 | X |
| Comparison 6 | 0.96 | 81.19 | 4.08 | 15 | ⊚ |
| Comparison 7 | 0.76 | 87.15 | 6.41 | Non-conductive | ⊚ |
| Comparison 8 | 0.72 | 87.12 | 6.35 | Non-conductive | ⊚ |
| Comparison 9 | 0.66 | 87.11 | 6.42 | Non-conductive | ⊚ |
| Comparison 10 | 0.75 | 87.08 | 6.36 | Non-conductive | ⊚ |
| Comparison 11 | 0.75 | 87.18 | 6.40 | Non-conductive | X |
| Comparison 12 | 1.12 | 85.02 | −2.48 | 1000 | Δ |

^{a}b* value is better in a range of −2.0 to 2.0;
^{b}white spots ≦3 is denoted by ⊚; 3<white spots ≦0 is denoted by Δ; white spots >10 is denoted by X.

Comparing the structure of the transparent conductive laminates of Table 2 and the test results of Table 3, the corrosion-resistant films can effectively inhibit generation of white spots (white spots≦3) and would not lead to increase of surface resistance. The thickness of the corrosion-resistant film is better not less than 20 nm.

To exhibit a better property of chromatism, b* value should be in a range of −2.0 to 2.0. Comparing examples 1 and 2 and comparisons 1, 4 and 6, when the content of the carbon nanotubes of the corrosion-resistant film is 4.06 v/v % and the thickness thereof is lower than 30 nm, b* is larger than 2, which means poor improvement in chromatism. Further, when the content of the carbon nanotubes of the corrosion-resistant film is 29.73 v/v % and the thickness thereof is lower than 20 nm, it is also ineffective to improve chromatism.

### Example 4

The steps for fabricating the transparent conductive laminate of example 4 are the same as steps (1) to (6) of example 1. The corrosion-resistant film of example 4 has a thickness of 130 nm.

### Example 5

The steps for fabricating the transparent conductive laminate of example 5 are the same as steps (1) to (3), (5) and (6) of example 1, and step (4) is changed to add the carbon nanotubes and WPU-2 into isopropanol aqueous solution (water (wt %): ispropanol (wt %) is 1:0.7), and then uniformly dispersed to form the corrosion-resistant solution containing 0.2 wt % of both the carbon nanotubes and the waterborne polyurethane. After drying, the content of the carbon nanotubes of the corrosion-resistant film is 29.73 v/v %. The corrosion-resistant film of example 5 has a thickness of 120 nm.

### Comparisons 13 and 14:

The steps for fabricating the transparent conductive laminates of comparisons 13 and 14 are the same as steps (1) to (3), (5) and (6) of example 1, and step (4) is changed to add the carbon nanotubes and WPU-2 into isopropanol aqueous solution (water (wt %): ispropanol (wt %) is 1:0.7), and then uniformly dispersed to form the corrosion-resistant solution containing 0.2 wt % of both the carbon nanotubes and the waterborne polyurethane. After drying, the content of the carbon nanotubes of the corrosion-resistant films of comparisons 13 and 14 is 29.73 v/v %. The corrosion-resistant film of comparison 13 has a thickness of 130 nm. The corrosion-resistant film of comparison 14 has a thickness of 150 nm.

### Comparison 15:

The steps for fabricating the transparent conductive laminate of comparison 15 are the same as steps (1) to (6) of example 1. The corrosion-resistant film of comparison 15 has a thickness of 150 nm.

The compositions and the structures of both examples 4 and 5 and comparisons 13 to 15 are illustrated in Table 4, and the test results are also summarized in Table 5.

TABLE 4

| | Corrosion-resistant film | | | | |
|---|---|---|---|---|---|
| | | | Content of | | |
| | | | carbon | | |
| | | | nanotubes of | Thickness | |
| | Carbon | | thin film^{a} | of thin film^{a} | Structure of |
| | nanotubes | WPU | (v/v %) | (nm) | transparent laminate^{b} |
| Example 4 | Yes | WPU-1 | 4.06 | 130 | . . . Ag/ITO/thin film^{a} |
| Example 5 | Yes | WPU-2 | 29.73 | 120 | . . . Ag/ITO/thin film^{a} |
| Comparison 13 | Yes | WPU-2 | 29.73 | 130 | . . . Ag/ITO/thin film^{a} |
| Comparison 14 | Yes | WPU-2 | 29.73 | 150 | . . . Ag/ITO/thin film^{a} |
| Comparison 15 | Yes | WPU-1 | 4.06 | 150 | . . . Ag/ITO/thin film^{a} |

^{a}the thin film is the corrosion-resistant film;
^{b}in the structure of the transparent conductive laminate, “. . .” is a abbreviation of “PET/ITO/”.

TABLE 5

| | | Light | | Surface | |
|---|---|---|---|---|---|
| | Haze | transmittance | b* | resistance | |
| | (%) | (%) | value^{a} | (Ω/□) | Appearance^{b} |
| Example 4 | 0.97 | 75.52 | 1.13 | 15 | ⊚ |
| Example 5 | 1.12 | 75.78 | 0.57 | 15 | ⊚ |
| Comparison 13 | 1.38 | 73.88 | 0.37 | 15 | ⊚ |
| Comparison 14 | 2.56 | 68.23 | 0.29 | 15 | ⊚ |
| Comparison 15 | 1.01 | 71.46 | 1.00 | 15 | ⊚ |

^{a}b* value is better in a range of −2.0 to 2.0;
^{b}white spots ≦3 is denoted by ⊚; 3<white spots ≦0 is denoted by Δ; white spots >10 is denoted by X.

Comparing the structures of the transparent conductive laminates of Table 4 and the results of Table 5, in order to allow the transparent conductive laminates in line with the needs of the downstream applications, the light transmittance should higher than or equal to 75%. As shown in those examples and comparisons, when the content of the carbon nanotubes of the corrosion-resistant film is 4.06 v/v % and the thickness thereof is larger than 150 nm, the light transmittance is less than 75%. Further, when the content of the carbon nanotubes of the corrosion-resistant film is 29.73 v/v % and the thickness thereof is larger than 130 nm, it also makes the light transmittance cannot achieve expectations.

### Working Range of Corrosion-Resistant Film

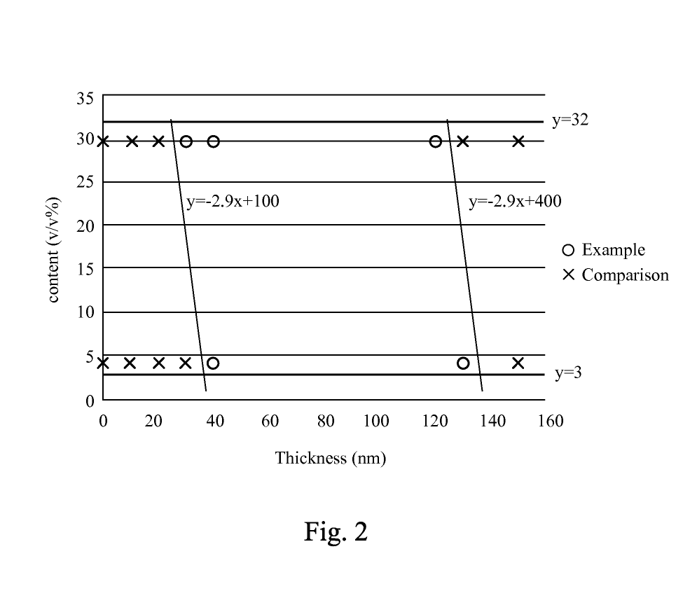

FIG. 2 is made from the test results of both Tables 3 and 5. According to the results of Tables 3 and 5, the content of the carbon nanotubes of the corrosion-resistant film is preferably in a range of 3 v/v % to 32 v/v %. In one aspect, if the content of the carbon nanotubes of the corrosion-resistant film is lower than 3 v/v %, the carbon nanotubes cannot form pathways, and thus, the surface resistance increases. In another aspect, if the content of the carbon nanotubes of the corrosion-resistant film is higher than 32 v/v %, the carbon nanotubes cannot be well-dispersed.

When the content of the carbon nanotubes of the corrosion-resistant film is 3 v/v %, the thickness thereof should be in a range of 30 nm to 150 nm. In one hand, when the thickness of the corrosion-resistant film is less than 30 nm, the chromatism thereof cannot be improved. In another hand, when the thickness of the corrosion-resistant film is larger than 150 nm, the light transmittance thereof would be decreased.

When the content of the carbon nanotubes of the corrosion-resistant film is 32 v/v %, the thickness thereof should be in a range of 20 nm to 130 nm. Because of increase in the proportion of the carbon nanotubes, it makes the film darker; however, the thickness of the corrosion-resistant film in the range mentioned above is still in the working range.

Based on the above results, it can be summarized as four straight lines, and the mathematical equations respectively are y=3, y=32, y=−2.9x+100, and y=−2.9x+400. According to FIG. 2, an enclosed area split by the four straight lines is the available range of the corrosion-resistant film. The four straight lines exists a simple mathematical relationship y=−2.9x+a, where y is 3 to 32 and a is 100 to 400.

As mentioned above, the corrosion-resistant film can effectively inhibit the generation of white spots by either oxidation or corrosion of metal to keep the conductivity and the light transmittance. Also, because the carbon nanotubes exhibits gray color, it makes the transparent conductive laminate exhibit neutral color back from yellow; that is, it can be used to improve the chromatism of the transparent conductive laminates.

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

1. A transparent conductive laminate, comprising:
a conductive multilayer comprising a substrate and a metal conductive layer; and
a corrosion-resistant film disposed on the conductive multilayer and being essentially consisting of a waterborne polyurethane (PU) and a plurality of carbon nanotubes dispersed in the waterborne polyurethane,
wherein a thickness (denoted as x nm) of the corrosion-resistant film and a content (denoted as y v/v %) of the carbon nanotubes have a mathematical relationship:
y=−2.9x+a (formula I),
wherein y is in a range of 3 to 32, and a is in a range of 100 to 400.

2. The laminate of claim 1, wherein the carbon nanotubes are single-walled carbon nanotubes, double-walled carbon nanotubes, multi-walled carbon nanotubes or a combination thereof.

3. The laminate of claim 1, wherein the waterborne polyurethane has at least one hydrophilic group selected from the group consisting of carboxylic acid group, sulfonic acid group, ammonium group, ethylene oxide group and a combination thereof.

4. The laminate of claim 1, wherein the substrate has a material selected from the group consisting of polyester-based resin, acetate-based resin, polyether-based resin, polycarbonate-based resin, polyamide-based resin, polyimide-based resin, polyolefin-based resin, acrylic resin, polyvinyl chloride-based resin, polystyrene-based resin, polyvinyl alcohol-based resin, polyarylate-based resin, polyphenylene sulfide-based resin, polyvinylidene chloride-based resin and a combination thereof.

5. The laminate of claim 1, wherein the metal conductive layer has a material selected from the group consisting of silver, aluminum, copper and a combination thereof.

6. The laminate of claim 1, wherein the conductive multilayer further comprises a conductive layer disposed between the metal conductive layer and the corrosion-resistant film.

7. The laminate of claim 1, wherein the conductive multilayer further comprises a conductive layer disposed between the metal conductive layer and the substrate.

8. The laminate of claim 6, wherein the conductive layer is made of a metal or a metal oxide.

9. The laminate of claim 8, wherein the metal is selected from the group consisting of silver, aluminum, copper and a combination thereof.

10. The laminate of claim 8, wherein the metal oxide is selected from the group consisting of indium oxide, tin oxide, zinc oxide, indium tin oxide, indium antimony oxide, zinc aluminum oxide, indium zinc oxide and a combination thereof.

11. The laminate of claim 7, wherein the conductive layer is made of a metal or a metal oxide.

12. The laminate of claim 11, wherein the metal is selected from the group consisting of silver, aluminum, copper and a combination thereof.

13. The laminate of claim 11, wherein the metal oxide is selected from the group consisting of indium oxide, tin oxide, zinc oxide, indium tin oxide, indium antimony oxide, zinc aluminum oxide, indium zinc oxide and a combination thereof.

14. A method for manufacturing the transparent conductive laminate of claim 1, the method comprising:
preparing a corrosion-resistant solution comprising a solvent, a plurality of carbon nanotubes and a waterborne polyurethane;
coating the corrosion-resistant solution on the conductive multilayer; and
drying the corrosion-resistant solution to form the corrosion-resistant film,
wherein a thickness (denoted as x nm) of the corrosion-resistant film and a content (denoted as y v/v %) of the carbon nanotubes have a mathematical relationship:
y=−2.9x+a (formula I),
wherein y is in a range of 3 to 32, and a is in a range of 100 to 400.

15. The method of claim 14, wherein the solvent is a mixture of water and isopropanol, and a weight ratio of the water to the isopropanol is 1:0.6 to 1:1.

16. The method of claim 14, wherein the carbon nanotubes and the waterborne polyurethane are present in a content ranging from 0.1 to 1.0% by weight relative to total weight of the anti-corrosive solution.
